(19) United States
(12) Patent Application Publication
(10) Pub. No.: US 2014/0207609 A1
(43) Pub. Date: Jul. 24, 2014

(54) GENERATING AND MAINTAINING A LIST OF PRODUCTS DESIRED BY A SOCIAL NETWORKING SYSTEM USER

(71) Applicant: Facebook, Inc., Menlo Park, CA (US)

(72) Inventors: Amanda Earhart, Santa Cruz, CA (US); Loren Alfred Cheng, Mountain View, CA (US)

(73) Assignee: Facebook, Inc., Menlo Park, CA (US)

(21) Appl. No.: 13/748,222

(22) Filed: Jan. 23, 2013

(51) Int. Cl. G06Q 30/06; G06Q 50/00

(52) U.S. Cl. CPC G06Q 30/0631; G06Q 50/01
USPC 705/26.7

(57) ABSTRACT

A social networking system associates a wish list with a user's profile on the system. Additional users connected to the user may add products to the user to the user's wish list. The user is notified of products added to its wish list, allowing the user to approve or reject addition of the products to its wish list. Allowing other users to add products to a user's wish list creates a dialog between users around the added products. Users may also comment on products presented via a wish list page, allowing conversations to be created between users about various products on a user's wish list, enabling further conversation between users.

### BACKGROUND

This invention relates generally to social networking and, more specifically, to maintaining a socially-generated listing of desired goods and/or services for a social networking system user.

Social networking systems have become prevalent in recent years because they provide a useful environment for users to connect and communicate with other users. In particular, a social networking system allows users to more efficiently communicate information that is relevant to their friends or other connections in the social network. Social networks typically incorporate a system for maintaining connections among users in the social network and links to content that are likely to be relevant to the users. Social networks also collect and maintain information about the users of the social network. This information may be static, such as geographic location, employer, job type, age, music preferences, interests, and a variety of other attributes, or it may be dynamic, such as tracking a user's actions within the social network. This information can then be used to target information delivery so that information more likely to be of particular interest to a user can be communicated to that user.

Users of the social networking system can share their interests in a brand or product, which can be displayed to viewing users in the social network. Users can also share links with each other to third party websites that include products of interest. However, current social networking systems do not provide a method for a user to identify products that the user desires. While certain retail systems allow users to identify products to purchase (a “wish list” for the user), these retail systems merely provide a static list. Users infrequently access these generated wish lists, limiting their ability to incite users into purchasing the products or services specified by the wish list. Additionally, these conventional wish lists are user-specific and do not allow a users to suggest products to other users or to interact with others about products on another user's wish list.

### SUMMARY

To increase social engagement with products in a social networking system, a wish list is associated with a target user's profile maintained by the social networking system. The wish list identifies products in which the target user has an interest in acquiring. Examples of products include goods, services or other items. A wish list page for the target user is generated from the target user's wish list, allowing the contents of the target user's wish list to be presented to other social networking system users, which may comment on products identified via the target user's wish list page. Additionally, social networking system users may suggest products for addition to the target user's wish list, causing the target user to be notified of the suggested products. In some embodiments, the target user may accept or reject inclusion of the suggested products, allowing the target user to control the products included on its wish list. Addition of the product to the target user's wish list can be displayed to other social networking system users connected to the target user.

While the target user may identify products included on its wish list, other users, such as users connected to the target user, may suggest products for inclusion on the target user's wish list. The social networking system may also suggest products for inclusion on the target user's web page either to the target user or to another user for suggestion to the target user. For example, the social networking system analyzes the target user's affinities for brands, products and/or categories, characteristics of products included on the target user's wish list, products included on wish lists of users connected to the target user, or products included on wish lists of users to which the target user has at least a threshold affinity.

In addition to identifying products on a target user's wish list, the target user's wish list page allows users to post comments associated with products on the target user's wish list. For example, a user may select a description of a product and provide a comment that is posted to the target user's wish list page and associated with the selected product description. The comment, as well as an identification of the user posting the comment, is presented to the target user's with list page to generate a dialog about the selected product between social networking system users.

### BRIEF DESCRIPTION OF THE DRAWINGS

FIG. 1 is a high-level block diagram of a system environment for generating a wish list for a user in a social networking system, in accordance with an embodiment of the invention.

FIG. 2 is a flow chart of a process for generating a wish list for a user in the social networking system, in accordance with an embodiment of the invention.

FIG. 3 is a flow chart of a process for displaying the wish list of a user and comments from other users, in accordance with an embodiment of the invention.

FIG. 4 is a flow chart of a process for selecting additional products to recommend to a user's wish list, in accordance with an embodiment of the invention.

FIG. 5 is an example of a wish list page in the social networking system, in accordance with an embodiment of the invention.

FIG. 6 is an example of a user profile page in a social networking system allowing other users to add a product to a user's wish list, in accordance with an embodiment of the invention.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Overview

A social networking system enables users to communicate and interact with each other. Users join the social networking system and add connections to other users. Additionally, users may share information that may be interesting or relevant to other users, such as interests, news, links, comments, photos, or multimedia. Interests in a brand or product can be shared via the social networking system, allowing creation of a dialog where users can comment on or like another user's post. Social networking system users include individuals as well as entities, such as businesses, that join the social networking system and form connections to other users.

In addition to allowing users to exchange information with each other, the social networking system allows a user to generate a wish list of desired products. The wish list is associated with a user profile, allowing the user to subsequently review the desired products. As used herein, “product” is an item, thing, good, object or service that is offered for purchase. A user may share its associated wish list with other users, receive suggestions for products to be added to the wish list from other users, and add products to the wish list. Additionally, a user may view and comment about products included on wish lists of other users connected to the user. This allows social networking system users to establish a dialog about their wish lists, increasing the frequency with which a user interacts with its wish list.

### System Architecture

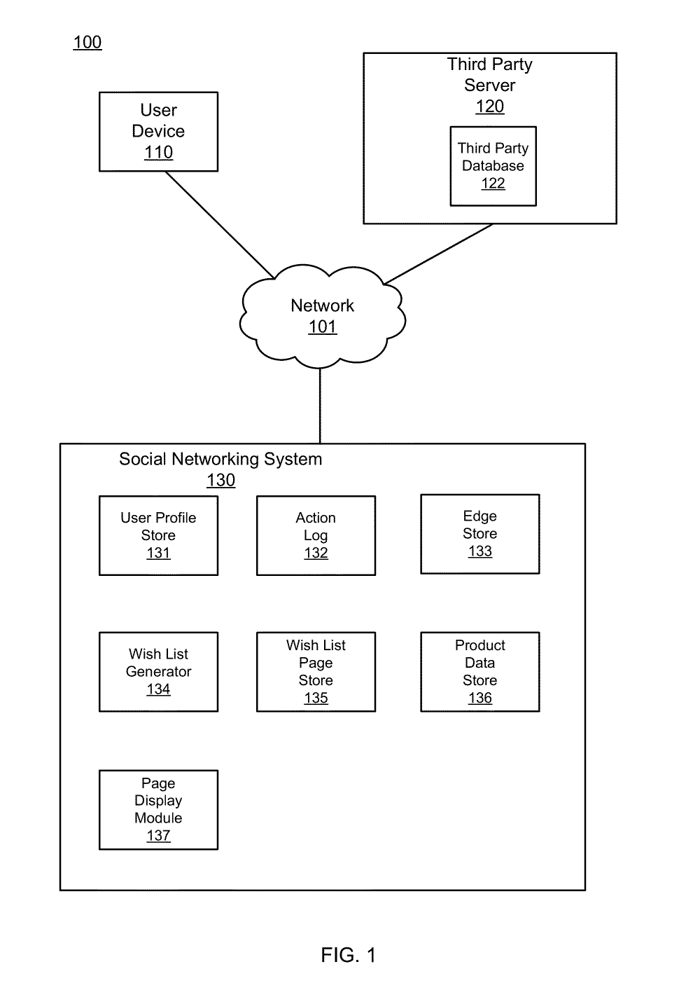

FIG. 1 is a high level block diagram illustrating a system environment 100 suitable for operation of a social networking system 130. The system environment 100 comprises a network 101, one or more user devices 110, a third party server 120, and a social networking system 130. In alternative configurations, different and/or additional components may be included in the system environment 100. Additionally, the embodiments described herein may be adapted to online systems that are not social networking systems.

The network 101 is a communication pathway between one or more user devices 110, a third party server 120, and/or a social networking system 130. The network 101 may comprise any combination of local area and/or wide area networks using both wireless and/or wired communication systems. For example, the network 101 may include the Internet, as well as mobile telephone networks. In one embodiment, the network 101 uses standard communications technologies and/or protocols. Hence, the network 101 may include links using technologies such as Ethernet, 802.11, worldwide interoperability for microwave access (WiMAX), 2G/3G/4G mobile communications protocols, digital subscriber line (DSL), asynchronous transfer mode (ATM), InfiniBand, PCI Express Advanced Switching, etc. Similarly, the networking protocols used on the network 101 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), etc. The data exchanged over the network 101 can be represented using technologies and/or formats including image data in binary form (e.g. Portable Network Graphics (PNG)), the hypertext markup language (HTML), the extensible markup language (XML), etc. In addition, all or some of links can be encrypted using conventional encryption technologies such as secure sockets layer (SSL), transport layer security (TLS), virtual private networks (VPNs), Internet Protocol security (IPsec), etc. In another embodiment, the entities on the network 101 can use custom and/or dedicated data communications technologies instead of, or in addition to, the ones described above.

The user device 110 may be a desktop computer, laptop computer, portable computer, smart phone, personal digital assistant (PDAs) or any other device including computing functionality and data communication capabilities. The user device 110 is configured to communicate with the social networking system 130 or the third party server 120 via the network 101. In one embodiment, the user device 110 executes an application allowing the user of the user device 110 to interact with the social networking system 130.

The third party server 120 includes a third party database 122. The third party database 122 stores data for one or more web pages presented associated with a third party as well as additional data associated with the third party. For example, the third party database 122 includes information about the web page and/or data about the products on one or more of the web pages. A third party web page may display information about products, a brand, or a business, and may also enable the purchase of products. The third party server 120 provides content, such as web pages to the user device 110 via the network 101, allowing a user to interact with the third party server content through the user device 110.

In one embodiment, a user of the social networking system 130 may include products on the user's wish list maintained by the social networking system 130 from a web page provided by the third party server 120 (a “third party web page”). Additionally, users of the social networking system 130 may suggest products for another user's wish list from the third party web page. The third party web page may use an application programming interface (API) for retrieving a user's information from the social networking system 130 and/or for communicating information to the social networking system 130. For example, the third party web page includes instructions that, when executed by the user device 110, retrieve data from the social networking system 130 or transmit data to the social networking system 130. In one embodiment, the instructions comprise a widget, a social plug-in, programmable logic, or code snippet. The instructions may generate a frame within the third party web page, such as an iframe, that includes information from the social networking system 130. For example, execution of the instructions in the third party web page by the user device 110 generates a frame within the third party web page that includes an action button allowing a user to interact with data stored in the social networking system. For example, a “suggest” button is included in a frame within the third party web page that allows a user to include information about a product on the third party web page into the user's wish list maintained by the social networking system 130. Exchange of information between a social networking system 130 and web pages provided by a third party server 130 is further described in U.S. patent application Ser. No. 12/764,929, filed on Apr. 21, 2010, which is incorporated by reference herein in its entirety.

In other embodiments, execution of the instructions in the third party web page retrieves information about the user's identity from the user device 110 when third party web page is rendered. Execution of the instructions may retrieves information about the identity of the user and a list of other users who are connected to the user from the social networking system 130. The retrieved list of users is displayed to the viewing user, such as through a frame generated within the third party web page, and the viewing user includes a product displayed on the third party web page on a user's wish list by selecting the a user from the list of connected users. Information describing the viewing user, the selected user, and the product are then sent to the social networking system 130. In some embodiments, the viewing user's actions on the third party web page (e.g., clicking on a suggest button for a product) are sent directly to the social networking system 130, so the third party server 120 does not receive or store data about the identity of the viewing user, the viewing user's connections, or the viewing user's actions on the third party web page. This maintains the privacy of the viewing user and his actions on the third party web page. Providing content from the social networking system 130 to a web page provided by a third party server 120 is further described in U.S. Pat. No. 8,250,145, which is incorporated by reference herein in its entirety.

The social networking system 130 includes a user profile store 131, an action log 132, an edge store 133, a wish list generator 134, a wish list page store 135, a product data store 136, and a page display module 137. In other embodiments, the social networking system 130 may include additional, fewer, or different components for various applications. Conventional components such as network interfaces, security functions, load balancers, failover servers, management and network operations consoles, and the like are not shown so as to not obscure the details of the system architecture.

Each user of the social networking system 130 is associated with a user profile, which is stored in the user profile store 131. A user profile includes information about the user that is explicitly provided by the user and can include profile information inferred by the social networking system 130. In one embodiment, a user profile includes multiple data fields, each data field describing one or more attributes of the user. The user profile information stored in user profile store 131 can include biographic, demographic, and other types of descriptive information about the user, such as age, gender, location, hobbies, preferences, interests, work experience, educational history, and the like. The user profile store 131 can also store content items associated with the user profile, such as images, photos, text, multimedia content, videos, or audio files. In certain embodiments, images of users may be tagged with identification information of users of the social networking system 130 displayed in an image. A user profile in the user profile store 131 may also maintain references to actions by the corresponding user performed on content items and stored in the action log 132. Additionally, the user profile store 131 may store data about posts, comments, status updates, images, links, multimedia, video, or other content that is displayed on the user profile; alternatively, the social networking system 130 includes a content store for storing data that may be presented on a user profile.

The user profile store 131 stores user profiles for entities other than individuals, such as businesses, companies, brands, communities, or organizations. This allows an entity to establish a presence on the social networking system 130 for connecting and exchanging content with other social networking system users. The entity can have a user profile that includes information about the entity, such as geographic location(s), product information, brand information, advertisements, deals, or other suitable information about the entity or the products offered by the entity.

The action log 132 stores information about the actions by users in the social networking system 130 as well as actions by users on websites external to the social networking system, such as the third party server 120. Such actions can include liking or commenting on a post, uploading an image or link, sending or reading a message, clicking on a link or image, viewing content associated with another user, adding content to another user's page, among others. In some examples, the action log 132 stores actions between a user and a user profile of an entity (e.g., a brand page) within the social networking system 130, or between a user and an object on a user profile. The action log 132 stores actions by a user with a product on a wish list page. For example, if a user comments on a product on a wish list page, the action log 132 stores the action in association with the user and the product. In some embodiments, data from the action log 132 is used to infer interests or preferences of the user, augmenting the interests included in the user profile and allowing a more complete understanding of user preferences.

The action log 132 may also store user actions taken on external websites. For example, an e-commerce website that primarily sells sporting equipment at bargain prices may recognize a user of a social networking system 130 through social plug-ins that enable the e-commerce website to identify the user of the social networking system 130. Because users of the social networking system 130 are uniquely identifiable, e-commerce websites, such as this sporting equipment retailer, may use the information about these users as they visit their websites. The action log 132 records data about these users, including webpage viewing histories, advertisements that were engaged, purchases made, and other patterns from shopping and buying.

The edge store 133 stores data about edges, which are connections between users and/or between users and objects (e.g., pages) in the social networking system 130. Some edges may be defined by users, allowing users to specify their relationships with other users. For example, users may generate edges with other users that parallel the users' real-life relationships, such as friends, co-workers, partners, and so forth. Other edges are generated when users interact with objects in the social networking system 130, such as expressing interest in a page on the social networking system, sharing a link with other users of the social networking system, and commenting on posts made by other users of the social networking system 130.

The edge store 133 can also store affinity scores for objects, interests, pages, and other users. Affinity scores can be computed by the social networking system 130 over time to approximate a user's affinity for an object, interest, and other users based on the actions performed by the user. A user's affinity may be computed by the social networking system 130 over time to approximate a user's affinity for an object, interest, and other users in the social networking system 140 based on the actions performed by the user. Computation of affinity is further described in U.S. patent application Ser. No. 12/978,265, filed on Dec. 23, 2010, which is hereby incorporated by reference in its entirety. For example, if a user likes a page about Cyclocross bikes and posts frequently about biking, the social networking system 130 can determine that the user has a high affinity for bikes or biking and can calculate an affinity score accordingly. The affinity score can be stored in the edge store 133 in association with the edge and/or the user.

Hence, user profile store 131, the action log 132 and the edge store 133 allow the social networking system 130 to generate a social graph with nodes connected by edges. Nodes include users and objects of the social networking system 130, such as web pages embodying concepts and entities, and the edges connect the nodes. Some edges between users can be defined by real-life relationships. For example, users may generate edges with other users that are labeled as friends, colleagues, acquaintances, close friends, partners, boyfriend and girlfriend, husband and wife, and so forth. Other edges are generated when users interact with objects in the social networking system 130, such as when a user likes a profile page of a brand or company.

The wish list generator 134 generates a wish list identifying products that a user of the social networking system 130 would like to purchase. The wish list is associated with the user profile of the user and includes information describing various products. For example, a user's wish list includes a photo or an image of a product, a price, and specifications about the product, brand information, links to third party websites for purchasing the product, deals or coupons, or other information about the product.

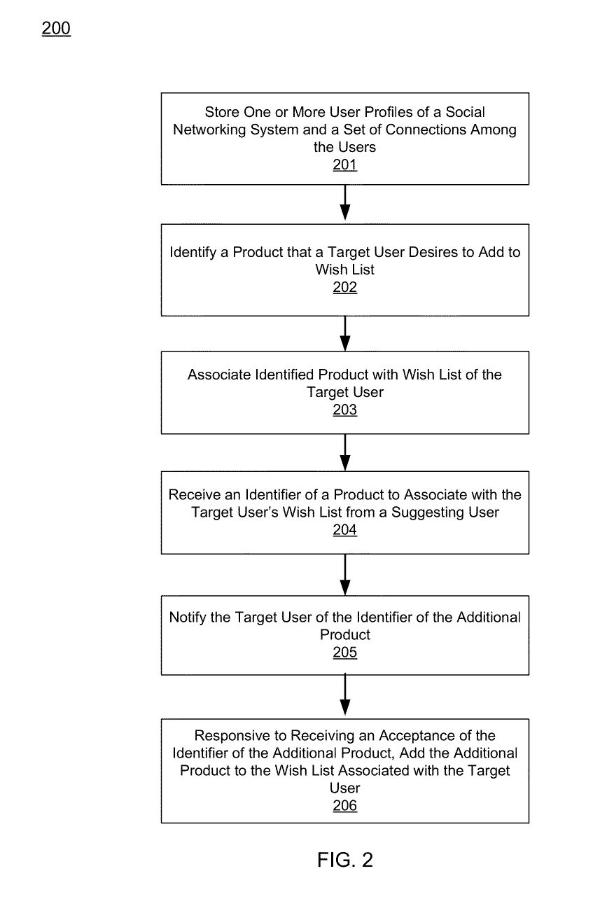

As further described below in conjunction with FIGS. 2-4, various methods may be used by the wish list generator 134 to generate a wish list. As used herein, a “target user” is a user associated with a wish list, and other users can suggest products for the target user's wish list. In one embodiment, users connected to the target user may suggest products for the target user's wish list, while users not connected to the target user may not suggest products for the target user's wish list. Alternatively, any user may suggest products for the target user's wish list. The target user may specify one or more privacy settings in its associated user profile to limit access to its wish list and to limit users able to suggest products for its wish list. As used herein, a user suggesting a product for the target user's wish list is called a “suggesting user.”

The wish list generator 134 may initially associate a wish list with no products identified (an “empty” wish list) with a target user. In one embodiment, the target user identifies a product for inclusion on the wish list, and the wish list generator 134 stores information about the identified product with the wish list associated with the target user. Alternatively, the wish list generator 134 receives a suggestion from a suggesting user that identifies a product for addition to the target user's wish list. In one embodiment, the wish list generator 134 notifies the target user of the suggested product (e.g., by sending a notification message to the target user), allowing the target user to approve or reject the suggested product. If the target user approves the suggested product, the wish list generator 134 adds the suggested product to the wish list. In some embodiments, the wish list generator 134 receives an identification of a suggested product from the suggesting user and adds the suggested product to the target user's wish list, without approval from the target user. The wish list is stored and presented using as a wish list page is associated with the target user's user profile. Details about generating and curating the wish list are described below in conjunction with FIGS. 2-4.

The wish list generator 134 may also remove items from the wish list. For example, a target user sends a request to the wish list generator 134 identifying a product to remove from the wish list. For example, the target user interacts with an element presented by the wish list page to identify a product for removal from the target user's wish list or may use any other suitable communication channel to request removal of a product from the target user's wish list. The target user may remove a product from the target user's wish list when the target user has purchased the product or when the target user no longer desires the product to be on the wish list. Hence, the target user curates and manages the wish list over time by directly adding or removing items from the wish list or by approving and adding products suggested by other users to the wish list. The products or items on the wish list may be curated according to the target user's changing interests or purchase history.

The wish list page store 135 stores the wish lists and information for generating a wish list page for social networking system users. The wish list page store 135 may store data associated with the wish list, such as the information, photo, or specification about each product. Alternatively, the wish list page store 135 stores information identifying sources from which information about products on a wish list is retrieved. The wish list page store 135 may also store data about the display of the wish list page. For example, different social networking system users may specify different formats for display of their wish list pages by modifying the number of products shown, the number of comments shown, the ordering of products shown, or any other suitable display configuration.

In one embodiment, the social networking system 130 includes a product data store 136 including information about products. For example, an entity user of the social networking system 130 (business, brand, company, etc.) is associated with a list of products and the product data store 136 stores information about the products along with an association between the products and the entity. The product data store 136 may also associate a product identifier with each product, so when a target user identifies a product, the product identifier of the product is used to retrieve data associated with the product from the product data store 136. In one embodiment, the product data store 136 may store information about a product from multiple entities. For example, the product data store 136 associates pricing or customization options from multiple entities providing a product identifier with the product. The wish list generator 134 may retrieve the information describing a product from the product data store 136 for inclusion in a wish list or may store information for retrieving the information describing the product from the product data store 136. For example, the product data store 136 stores a list of products relating to a brand, such as NIKE®, and the wish list generator 134 retrieves the information about the NIKE® products to suggest to a user or about the NIKE® products included on the wish list. An entity user may add products to the product data store 136 or update the list of products stored.

The page display module 137 generates a wish list page for a target user based on data in the wish list page store 135 associated with the target user. The wish list page generated by the page display module 137 may be displayed in association with the target user's profile. In some embodiments, the wish list page is displayed as a separate page from the user profile in the social networking system 130. The wish list page includes the products in the wish list, along with photos or information about the products. The generated wish list page also includes a section for receiving comments for various products from other social networking system users. Comments for a product are displayed proximate to the product on the wish list page. In some embodiments, the product is also associated with a “like” button, allowing other users to indicate that they like the product. An additional interface element, such as a “want” or “add” button may also be displayed on the wish list page proximate to various products, allowing a user viewing the wish list to add a product to its wish list by accessing the interface element. In other embodiments, a link to a third party web page for purchasing a product is displayed proximate to the product.

User-specific display settings may be stored in the wish list page store 135 or in the user profile store 131, and the appearance of the wish list page generated by the page display module 137 is modified based on the user-specific display settings. For example, a user may specify that the entire list of products on the user's wish list is displayed on the wish list page. As another example, a user may specify a group or limited number of products from the wish list that are presented on the generated wish list page. Based on one or more settings, the wish list page may display products in various orders. For example, products may be displayed based on chronological order, based on when the product was added to the wish list, or based on any other suitable criteria. Products on the wish list can also be displayed in an order based on the number of comments received, the number of likes associated with the product, or the popularity of the product on other users' wish lists. In other embodiments, products are displayed based on product type, product name, category, or brand.

The page display module 137 may also notify users connected to a target user of additions to the target user's wish list. For example, when a product is added to a target user's wish list, the page display module 137 generates a story identifying the product and the target user; the story is then distributed to other users connected to the target user. In one embodiment, the story is presented in a news feed of another user connected to the target user. For example, if Amanda suggests a NIKE® running shoe to a connected user Loren, and Loren adds the NIKE® running shoe to his wish list, the page display module 137 may generate a story, such as “Amanda suggested NIKE® running shoes to Loren,” or “Loren added NIKE® running shoes to his wish list.” The story may then be presented to other viewing users who are connected to the target user, the suggesting user, or both. In one embodiment, the product is displayed with information obtained from the wish list page store 135 and/or the user profile store 131 specifying other users connected to the user viewing the story that have the product on their wish list pages.

In some embodiments, the story includes a comment section allowing users viewing the news story to provide comments about the story and/or about the product and/or users identified by the story. A story may also be associated with a “want” button or link to allow a user viewing the story to add the product identified by the story to its own wish list by accessing the “want” button or link. In other embodiments, the story includes a “suggest” button or link enabling the user viewing the story to suggest the product to a user connected to the user viewing the story by interacting with the “suggest” button or link. The story may also include inputs allowing a user viewing the story to “like” the story or to share the story with other users connected to the user viewing the story.

Additionally, the story about adding a product to the target user's wish list may be displayed on a profile page associated with the target user. If the added product was suggested by a suggesting user, the story may also be displayed on a profile page associated with the suggesting user. In another embodiment, the story describing addition of a product to the target user's wish list may be displayed on a brand page or profile page associated with an entity associated with the product. For example, the story is presented on a brand page for the product manufacturer, a brand page for an entity selling the product, or on a brand page of any other entity associated with the product added to the target user's wish list. As a specific example, a story about the addition of a NIKE® running shoe to a target user's wish list page may be published on a brand page in the social networking system 130 associated with NIKE®. In some embodiments, the story about the added product includes a link to a third party web page for viewing and/or purchasing the product identified by the story.

In one embodiment, a product on the wish list is associated with one or more voting buttons and a question. The voting button allows users viewing the target user's wish list to vote on a question about the target user and the product. For example, the viewing user may be presented with a question about a shirt on a target user Bob's wish list, such as “Would Bob look good in this?” The viewing user may respond by selecting the “Yes” or “No” voting button, increasing user interaction with the wish list. Various other types of questions about the product and the target user may be presented to viewing users. Providing a question associated with a product allows users to easily interact with products presented via the wish list. Thus, the voting buttons allow viewing users to further engage with other user's wish lists, in addition to liking, commenting on, or suggesting products for a user's wish list.

### Generating and Curating Wish Lists

Various methods are presented herein for suggesting and adding a product to a target user's wish list. FIG. 2 illustrates a method 200 for suggesting a product for a target user's wish list. In one embodiment, a social networking system 130 stores 201 one or more profiles of users and a set of connections among the users, including a user profile of a target user. In one embodiment, the target user identifies 202 a product that the target user desires, and the wish list generator 134 associates 203 the identified product with a wish list associated with the target user. For example, the page display module 137 generates a message, notification, recommendation, or other interface prompting the target user to identify one or more products that the user desires. Data describing one or more products identified by the target user is communicated to the wish list generator 134, which retrieves data associated with the identified one or more products from the product data store 136 or from another suitable source. Based on the retrieved data describing products identified by the target user, the wish list generator 134 includes a description of the one or more products on the wish list associated with the target user.

For example, the target user selects products to be added directly to his or her wish list via a third party web page. In one embodiment, the target user interacts with a plug-in, widget, frame, or other suitable interface displayed on the third party web page to identify a product from the third party web page for inclusion on the target user's wish list. Accessing the interface presented on the third party web page communicates an identifier of a product associated with the interface to the wish list generator 134 along with an identifier associated with the target user. The wish list generator 134 then includes a description of the selected product on the wish list associated with the target user.

The wish list generator 134 receives 204 an identifier for a product for addition to the target user's the wish list from a suggesting user, such as a user connected to the target user. The identifier may be an identification number, a catalog number, a product number, a name of the product, a code, or other data that uniquely identifies the product. In one embodiment, the wish list generator 134 notifies 205 the target user of the product suggested by the suggesting user. For example, the wish list generator 134 notifies 205 the target user of the identifier of the suggested product and/or of a description of the suggested product. The notification may also identify the suggesting user. The target user then accepts or rejects inclusion of the suggested product on the target user's wish list. Responsive to the wish list generator 134 receiving an acceptance of the suggested product, the wish list generator 134 adds 206 the additional product to the wish list associated with the target user. Alternatively, the target user may specify one or more settings in its associated user profile so the wish list generator adds 206 a product suggested by a suggesting user to the target user's wish list without notifying the target user. For example, the target user may identify a group of users so that a product suggested by a user in the group of users is automatically added to the target user's wish list without the target user accepting the suggested product.

Alternatively, the wish list generator 134 initially receives 204 suggestions of one or more products from other social networking system users, such as users connected to the target user. The wish list generator 134 retrieves data describing the suggested one or more products from the product data store 136 or from another suitable source. Using the data describing the suggested one or more products, the wish list generator 134 generates the wish list from data describing one or more of the suggested products. Hence, products included on the target user's wish list may be initially identified by the target user and/or may be initially identified based on products suggested to the target user by other users of the social networking system 130.

A suggesting user may suggest a product for inclusion on a target user's wish list via a third party web page. For example, a suggesting user visits a third party web page and selects a product for inclusion on the target user's wish list by accessing on a “suggest” button or link associated with the product on the web page and providing data identifying the target user, such as the target user's name or email address. As described above, the “suggest” button may be a widget or a plug-in that retrieves information from the social networking system 130 about the identity of the suggesting user and users that are connected to the suggesting user. In some embodiments, the widget or plug in requests the log-in information (e.g., user identifier and password) from the suggesting user to verify the identity of the suggesting user before retrieving the list users connected to the suggesting user from the social networking system 130. The retrieved list of users is then displayed to the suggesting user, which selects the target user from the list. Data identifying the suggesting user, the target user, and the suggested product are sent to the wish list generator 134 via the network 101.

In some embodiments, the wish list generator 134 notifies 205 the target user of the suggested product and identifies the suggesting user. The notification may be sent via email, text, message, or another notification method in the social networking system 130. The notification can include the identifier for the suggested product and/or a description of the suggested product (e.g., an image, a text description, etc.). The target user may accept the suggested product for addition to the wish list, causing a description of the suggested product to be added to the wish list, or the target user may reject the suggested product. In one embodiment, the wish list generator 134 may provide a message to the suggesting user that the target user has rejected inclusion of the suggested product on its wish list. This allows additional social networking system users to recommend products for the target user to include on its wish list, making the target user's wish list collaborative, while allowing the target user to retain control over the inclusion content of its wish list.

In another embodiment, the wish list generator 134 suggests a product for a target user's wish list by prompting a user connected to the target user to suggest a product. In one example, the wish list generator 134 presents a question to a user connected to the target user that identifies the target user and requests suggestion of a product for the target user's wish list. A user receiving the prompt may be selected based on the affinity of the target user for the user; for example a prompt is presented to connected users to which the target user has at least a threshold affinity or is presented to connected users to which the target user has the highest affinities.

For example, a user Bill receives a question to provide a suggestion of a product for a target user, Jane, who is connected to Bill in the social networking system 130. In one embodiment, the prompt accounts for the target user's affinities for objects in the social networking system 130. The prompt be presented to the connected user via its profile page or sent to the connected user via email, text message, push notification channel, recommendation unit, or another notification method in the social networking system 130. For example, the prompt may identify a product similar to, or associated with, a product or object with which the target user has at least a threshold affinity or a product similar to a product for which the target user has previously expressed a preference. For example, a prompt reads: “Jane likes Kawasaki motorcycles. Do you think she will like Honda motorcycles?” Bill can respond with a “yes” or “no.” If the connected user answers “yes,” the product identified by the prompt is suggested to the target user and the wish list generator 134 notifies the target user that the connected user suggested a product for his or her wish list as described above.

In other embodiments, the wish list generator 134 may select and suggest one or more products to add to the target user's wish list based on the target user's actions in the social networking system 130 and/or user profile information of the target user. Examples of the target user's actions in the social networking system 130 include: expressing a preference for one or more objects, providing comments associated with one or more objects, posting content associated with an object, and any other suitable action. By analyzing actions stored in the action log 132 associated with the target user, the wish list generator 134 identifies indicators of interest in various products or brands. For example, the wish list generator 134 analyzes the content of the target user's posts, comments on posts, or frequency of posting about a topic, product or brand. The wish list generator 134 may also account for the target user's affinities for objects from the edge store 133 when suggesting products for addition to the target user's wish list. For example, the target user may like, post, comment, or add photos or links on her profile about surfing, so the wish list generator 134 infers from these actions that the target user is interested in surfing products. Accordingly, the wish list generator retrieves information describing products associated with surfing from the product data store 136, or from another suitable source, and suggests the products associated with surfing (e.g., surf boards or surfing gear) to the target user via a recommendation, an email, a text message, a notification channel, a story in the target user's news feed, or any other suitable communication channel.

In another embodiment, the wish list generator 134 requests that a user connected to the target user suggest the products identified by the wish list generator 134 to the target user. The connected user can suggest the product(s) for the target user's wish list by selecting one or more of the identified products, and the wish list generator 134 sends the one or more products selected by the connected user to the target user for approval. If the target user accepts the suggested product, the product is added to the target user's wish list, as described above.

The wish list generator 134 may also suggest a product to add to the target user's wish list based on the target user's connections in the social networking system 130. The wish list generator 134 may access a target user's connections from the edge store 133. For example, if a target user is connected to a company's profile page, such as Christian Louboutin, in the social networking system 130, the wish list generator 134 determines that the target user likes Christian Louboutin shoes or likes the category of designer shoes based on the connection. Accordingly, the wish list generator 134 may recommend the target user add a pair of Christian Louboutin shoes to its wish list, directly or through a suggestion by a connected user, as described above. The target user's affinities for various connections may be used by the wish list generator 134 when suggesting a product. For example, a product with which the user has a threshold affinity for an entity, keyword or other object associated with the product is suggested to the target user.

In another embodiment, the wish list generator 134 uses a combination of the preceding factors to suggest products for inclusion on a target user's wish list. For example, the wish list generator 134 analyzes one or more of the target user's interests, connections, actions, and/or previous wish list products to determine products the target user is likely to include on its wish list. In some embodiments, a target user's age, location, demographic, marital status, education, job, or other information from the user profile of the target user may be used when selecting products for suggesting to the target user for inclusion on its wish list.

Receiving and Displaying Comments about Wish Lists

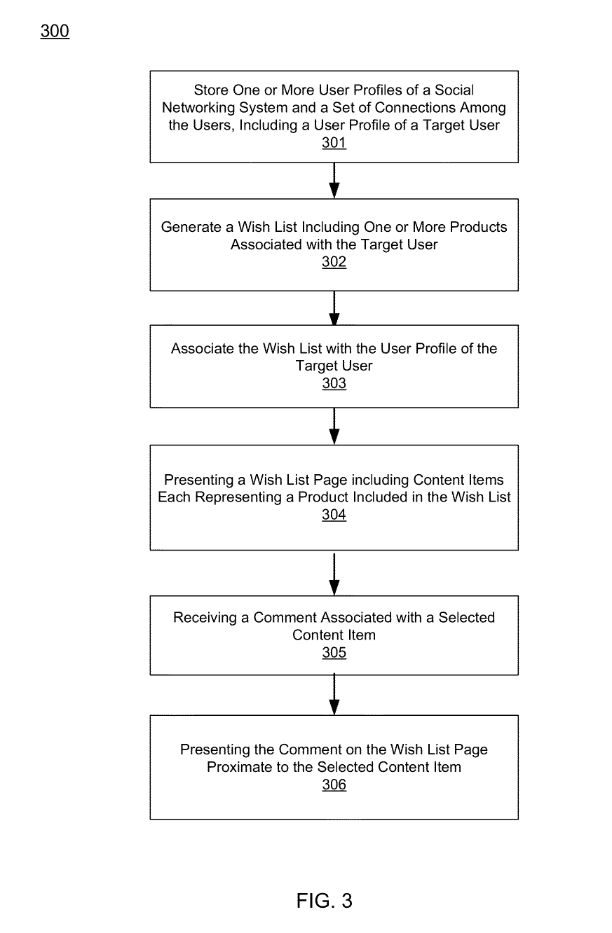

Referring now to FIG. 3, an example of a method 300 of receiving and displaying comments about a product on the wish list page is shown. The social networking system 130 stores 301 one or more user profiles of users in the social networking system and a set of connections among the users. One of the stored user profiles is associated with a target user. The social networking system 130 generates 302 a wish list including one or more products associated with the target user and associates 303 the wish list with the target user's user profile, as described above in conjunction with FIG. 2.

The page display module 137 presents 304 a wish list page including content items that each represent a product included in the wish list. The wish list page is accessible to other users of the social networking system 130 connected to the target user. In one embodiment, the wish list page is accessible to a subset of users of the social networking system 130 connected to the target user, such as a subset of users identified by the user profile. For example, the wish list page may be accessible to users connected to the target user by a specified connection type or types.

The page display module 137 receives 305 a comment from a user connected to the target user viewing the wish list page associated with a content item from the wish list page selected by the user connected to the target user (a “commenting user”). The received comment is presented 306 on the wish list page proximate to the selected content item, allowing the commenting user to participate in a dialog associated with the selected content item. In one embodiment, an identification of the commenting user is presented 306 along with the comment on the wish list page. For example, text of the comment is presented along with a user name and/or user image of the commenting user. The comments about the selected content item are displayed to additional users connected to the target user that view the wish list page, allowing the additional users to provide additional comments or to comment on the initial comment. The wish list page may be associated with the target user's profile page. For example, the target user's profile page includes a link to the target user's wish list page or includes content from the target user's wish list page.

Social networking system users provide comments about a product on the target user's wish list about the product in the social networking system 130, which may increase the sales of a product or improve the image or popularity of a brand or company, as more users become interested and engage in dialog about the product. Additional users may add the product to their wish lists or recommend it to other users, after commenting on the product or viewing the comments from other users about the product. Further, other users may identify additional products to the target user through comments associated with products included on the target user's wish list, exposing the target user to additional products.

### Selecting Additional Products for Wish Lists

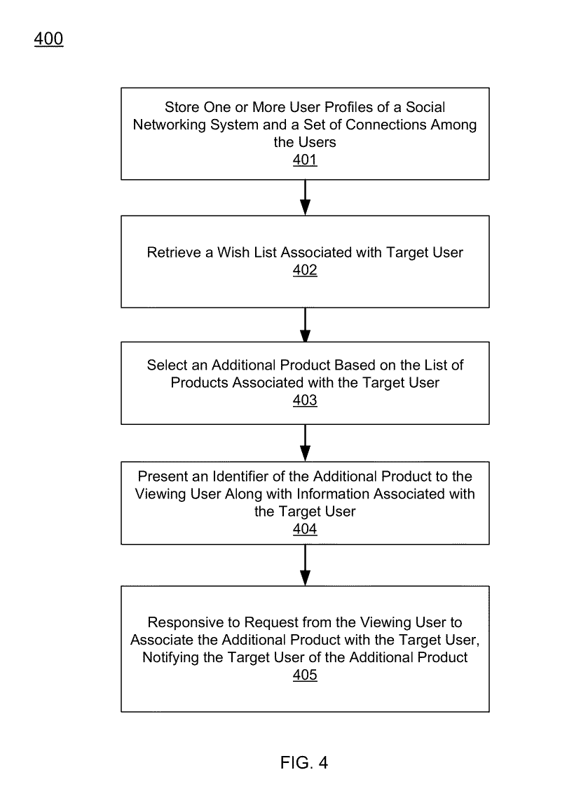

FIG. 4 shows one embodiment of a method 400 for selecting additional products for a target user's wish list based on the products on the wish list. The social networking system 130 stores 401 one or more user profiles of users of a social networking system and a set of connections among the users. A stored user profile is associated with a target user that is associated with a wish list including products associated with the target user. The stored user profiles also include a user profile associated with a viewing user, which is a social networking system user who connected to the target user. The wish list generator 134 retrieves 402 the wish list associated with the target user from the wish list page store 135 or from the user profile store 131. The wish list includes information describing one or more products associated with the target user.

Based on the description of the products included on the wish list, the wish list generator 134 selects 403 an additional product. For example, the wish list generator 134 analyzing characteristics of products already included in the target user's wish list. In one embodiment, an additional product is selected 403 based on the similarity between a category of the selected product and a category of the brands associated with products in the wish list or a category of the products included in the wish list. For example, a target user's wish list includes women's fashion bags from high fashion labels or couture brands (e.g., Louis Vuitton bags, Chanel bags). The wish list generator 134 determines that the products have common attributes (e.g., a designer women's bag, high fashion labels) and selects similar products for the target user.

In other embodiments, the wish list generator 134 selects 403 an additional product based on common attributes between products included on the target user's wish list and included on the viewing user's wish list. For example, if the viewing user and the target user both have women's fashion bags on their wish lists, the wish list generator 134 selects 403 designer bag, for example, and presents 404 the designer bag to the viewing user for recommending to the target user.

Alternatively, the wish list generator 134 selects 403 an additional product based on affinities of the target user for types, categories, or brands of products included on the target user's wish list. For example, the wish list generator 134 determines from the wish list page store 135 and/or from the edge store 133 that the user has at least a threshold affinity for golf (e.g., a threshold number or percentage of products on the target user's wish list are associated with golf, or the edge store 133 indicates that the target user has at least a threshold affinity for the keyword “golf”). The wish list generator 134 retrieves a list of golf-related products from the product data store 136 or a third party server 120, such as golf clubs, golf clothes, tees, or golf balls. These golf-related products may be directly presented 404 to the target user or as a suggestion to the viewing user for suggestion to the target user.

In another embodiment, the wish list generator 134 selects 403 an additional product based on the affinities for products shared between the viewing user and the target user. If the viewing user and the target user both have an affinity for golf products (e.g., they both have golf products on their wish lists, both have a threshold affinity for a one or more objects associated with “golf”), the wish list generator 134 presents 404 a golf product to the viewing user for recommending to the target user.

The viewing user is presented 404 with an identifier of the additional product and information about the target user. The viewing user requests that the additional product be added to the target user's wish list. The wish list generator 134 notifies 405 (e.g., generates a message) to the target user identifying the additional product and requesting the target user's approval of the additional product. As described above, the additional product is added if the target user approves the additional product. The selected additional product may be presented 404 to the target user directly or presented to the viewing user to suggest to the target user. The additional product may also be selected and presented to the target user in connection with a recommendation for a product from the viewing user. For example, if Amanda suggests NIKE® running shoes for Loren, then the wish list generator 134 can also suggest New Balance running shoes for Loren and present both products to Loren in one notification.

### Additional Methods for Selecting Products for Wish Lists

In other embodiments, the wish list generator 134 selects an additional product for a target user based on the popularity of a product in the social networking system 130. Popularity of a product can be determined based on the number of other users' wish lists including the product. A product's popularity may be determined based on its popularity among all users of the social networking system 130 or based on its popularity among a group of social networking system users 130. For example, a product's popularity may be based on the number of users connected to the target user having the product in their wish lists. For example, the wish list generator 134 determines that several users connected to the target user include a particular model of camera on their wish lists and selects the model of camera for the target user as a suggestion for inclusion on the target user's wish list.

In another embodiment, products can be selected for a target user's wish list from an entity's profile page. An entity's profile page can include description about products, photos of products, links to web pages, or other information about products. A target user or a suggesting user accesses the entity's profile page and views products via the profile page. One or more interfaces are included on the entity's profile page and associated with products, allowing a user to add a product to its wish list or to suggest a product for another user's wish list by accessing one of the interfaces.

Moreover, users may add products to a wish list by tagging objects in photos or images in the social networking system 130. Photos or images posted by social networking system users may be tagged to identify products included in the image or to identify products associated with the image. The social networking system 130 may prompt users to tag photos or images for products, for example, when uploading or viewing the photo or image. For instance, a photo can include a user wearing a Gap T-shirt, and the T-shirt can be tagged in the photo with the Gap brand and/or a Gap T-shirt label. Viewing users can view the tagged T-shirt and select an option to T-shirt to their wish list or to suggest the T-shirt to another user's wish list.

### Examples

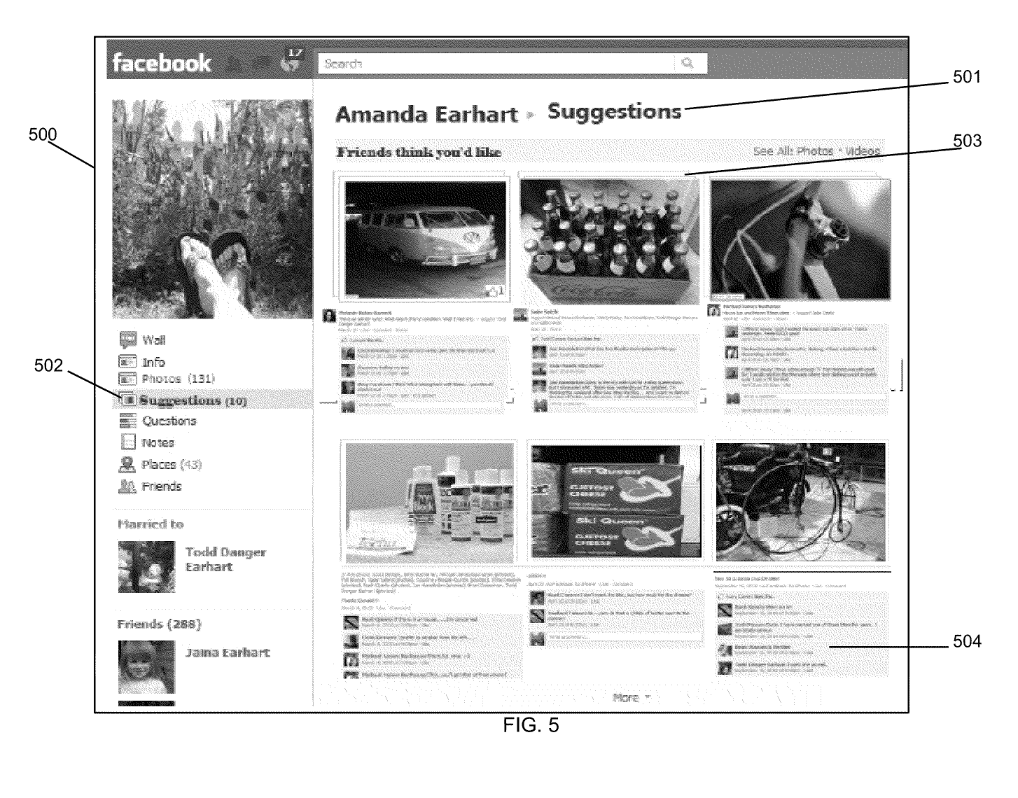

FIG. 5 shows an example wish list page 500 of a target user in the social networking system 130. The wish list page 500 includes one or more suggestions 501 from other users for inclusion on the wish list page 500. In the example of FIG. 5, the wish list page 500 is associated with a profile page of the target user via a link 502, and the wish list page 500 is titled “Suggestions”. Clicking on the “Suggestions” link 502 directs the viewing user to the wish list page. An example of a product 503 suggested by another user (a Coca-Cola drink) is shown on the wish list page, along with other products suggested by one or more social networking system users (e.g., in FIG. 5 a Volkswagon van, a bicycle, etc.). Each of the displayed products includes a comment section 504, where other viewing users can post comments about the product.

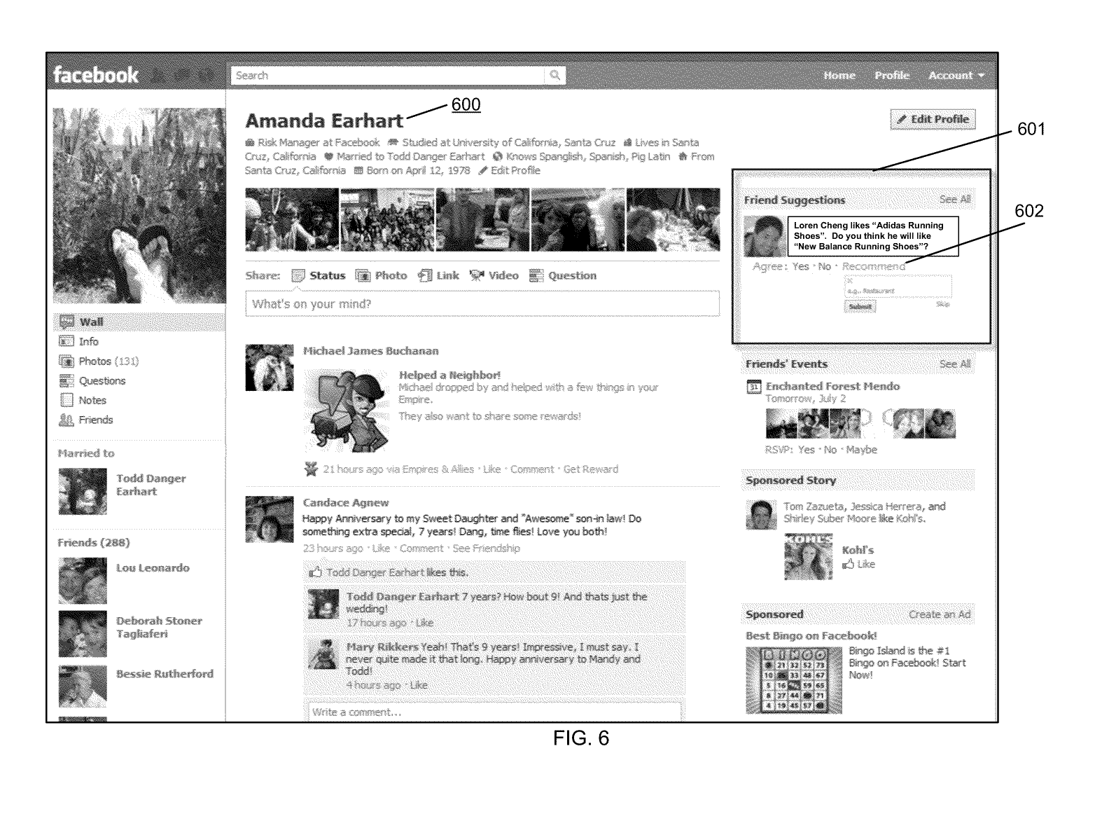

FIG. 6 is an example of a profile page 600 of a suggesting user of the social networking system 130. In FIG. 6, the profile page 600 is for a viewing user, Amanda, connected to another user, Loren, via the social networking system 130. The profile page 600 includes a suggestion box 601 presenting a question to Amanda. The question may identify a product or brand that the user connected to the viewing user likes or has included on its user profile and identifies an additional product. The question prompts the viewing user to provide input whether the user will like the additional product. The prompt reads, “Loren likes Adidas running shoes. Do you think he will like New Balance running shoes?” Amanda can respond with a “yes” or “no” 602. If the response is “yes,” a suggestion for New Balance running shoes is communicated to Loren. In some embodiments, when Loren accepts the suggested product, the product is added to his wish list. In other embodiments, the suggested product is automatically added to the wish list and displayed directly to Loren's wish list page.

By associating a target user's wish list with the target user's social networking system user profile, the target user's wish list is closely linked to the target user's identity within the social networking system. This may encourage the target user to curate its wish list as other users connected to the target user may view the target user's wish list as an extension of the target user's user profile. For example, a portion of or all of the products on the target user's wish list may be published or displayed to other users who are connected to the target user in the social networking system, and the target user's wish list of products may convey information about the target user's interests, hobbies, tastes, and so forth. In one example, a BMW® motorcycle on Loren's wish list may present a message to other users that Loren is interested in action sports or likes expensive sporting vehicles. As other users view, comment, and/or interact with the target user's wish list, the target user may be compelled to curate the wish list to further define his or her online identity. When other users who are connected to the target user suggest products for the target user's wish list, the other users may help the target user shape or define its online identity in the social networking system.

### SUMMARY

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
storing one or more user profiles of a plurality of users of a social networking system and a set of connections among the users, the one or more user profiles including a user profile of a target user of the plurality of users;
associating a wish list with the target user, the wish list for associating one or more products with the user profile of the target user;
receiving an identifier of a suggested product to associate with the target user from a suggesting user who is connected to the target user in the social networking system;
notifying the target user of the suggested product; and
responsive to receiving an acceptance of the suggested product, adding a description of the suggested product to the wish list associated with the target user.

2. The method of claim 1, wherein associating the wish list with the target user comprises:
receiving an identifier of a product from the target user; and
including a description of the product on the wish list associated with the target user.

3. The method of claim 1, wherein associating the wish list with the target user comprises:
retrieving actions associated with the target user stored by the social networking system;
identifying a product to associate with the target user to the target user based on the retrieved actions associated with the target user; and
including a description of the product on the wish list associated with the target user.

4. The method of claim 3, wherein the retrieved actions associated with the target user are selected from a group consisting of: expressing a preference for one or more objects, providing comments associated with one or more objects, posting content associated with an object, and any combination thereof.

5. The method of claim 1, wherein receiving the identifier of the additional product comprises receiving the identifier from a third party web page that is external to the social networking system.

6. The method of claim 5, wherein receiving an identifier of an additional product occurs responsive to a user connected to the target user interacting with an interface on the third party web page that communicates data to the social networking system.

7. The method of claim 1, wherein receiving the identifier of a suggested product to associate with the target user from a suggesting user that is connected to the target user in the social networking system comprises:
presenting one or more products to the suggesting user, the one or more products determined based in part on the target user's affinities for the one or more products; and
receiving a selection from the one or more products from the suggesting user.

8. A computer-implemented method comprising:
storing one or more user profiles of users of a social networking system and a set of connections among the users, the one or more user profiles including a user profile of a target user;
generating a wish list identifying one or more products associated with the target user;
associating the wish list including the one or more products with the user profile of the target user;
presenting a wish list page including content items each representing a product included in the wish list, the wish list page accessible to other users of the social networking system connected to the target user;
receiving a comment associated with a content item selected from the wish list page from a commenting user connected to the target user; and
presenting the comment and an identification of the commenting user on the wish list page proximate to the selected content item.

9. The method of claim 8, wherein the wish list page is associated with a profile page of the target user.

10. The method of claim 8, wherein the content items comprise one or more selected from a group consisting of: a logo, a photo, an image, data about the product, and any combination thereof.

11. The method of claim 10, wherein the content items are organized by product type or product name or chronologically on the wish list page.

12. The method of claim 8, further comprising presenting a story describing the comment and identifying the content item to the target user.

13. The method of claim 8, further comprising displaying the product as a story included in a news feed of stories presented to users connected to the commenting user.

14. The method of claim 13, wherein the story indicates that an additional user connected to the target user suggested the product for the wish list.

15. The method of claim 13, wherein the story comprises information about an additional user connected to the target user having a product associated with the selected content item on a wish list page associated with the additional user.

16. A computer-implemented method comprising:
storing one or more user profiles of users of a social networking system and a set of connections among the users, the one or more user profiles including a user profile of a viewing user;
retrieving a user profile of a target user connected to the viewing user, the user profile of the target user associated with a wish list identifying products associated with the target user;
selecting an additional product based on the products identified by the wish list associated with the target user;
presenting an identifier of the additional product to the viewing user along with information associated with the target user; and
responsive to receiving a request from the viewing user to associate the additional product with the viewing user, sending a notification of the additional product to the target user.

17. The method of claim 16, further comprising:
including the additional product on the wish list associated with the target user when a response approving the additional product is received from the target user.

18. The method of claim 16, wherein selecting an additional product based on the products identified by the wish list associated with the target user comprises selecting a product having at least a threshold number of common attributes with a product identified by the wish list associated with the target user.

19. The method of claim 16, wherein selecting an additional product based on the products identified by the wish list associated with the target user comprises selecting a product based at least in part on the affinities between the target user and one or more of a product type, a brand, or a category of products associated with products identified by the wish list associated with the target user.

20. The method of claim 16, wherein selecting an additional product based on the list of products associated with the target user comprises determining the interests of the target user from the products identified by the wish list associated with the target user and a user profile of the target user.

21. The method of claim 16, wherein the notification to the target user includes an identification of the viewing user and a description of the additional product.
